(19) United States
(12) Patent Application Publication
(10) Pub. No.: US 2010/0052280 A1
(43) Pub. Date: Mar. 4, 2010

(54) Toothed rack or threaded rod

(75) Inventors: Roman Bilmayer, Mauren (LI); Ralf Eckstein, Feldkirch (AT)

Correspondence Address: WENDEROTH, LIND & PONACK, L.L.P., 1030 15th Street, N.W.,, Suite 400 East, Washington, DC, 20005-1503, US

(73) Assignee: ThyssenKrupp Presta Aktiengesellschaft

(21) Appl. No.: 12/588,545

(22) Filed: Oct. 19, 2009

Related U.S. Application Data
(63) Continuation of application No. PCT/AT2008/000114, filed on Mar. 28, 2008.

(30) Foreign Application Priority Data
Apr. 19, 2007 (DE) 10 2007 018 919.4

(51) Int. Cl. B62D 3/12; B62D 3/04; F16H 55/26; F16H 55/02

(52) U.S. Cl. 280/93.514; 74/422

(57) ABSTRACT

The invention relates to a toothed rod or a threaded rod, particularly for a steering device for a motor vehicle, comprising a first rod-shaped pan which has at least one element for converting a rotational movement into a translational movement, said element being the functional element of the toothed rod or threaded rod, and being particularly a teething and/or a threading for engaging in a threaded nut or a threaded mechanism. The invention also has a second rod-shaped part which is connected to the first rod-shaped part and which preferably has at least one additional functional element of the toothed rod or threaded rod. The rod-shaped parts have hollow cavities which open toward connection ends in which connecting pins of a separate connection part are held by a press fit for the purpose of connecting the rod-shaped parts.

This is a continuation of international application PCT/AT2008/000114, filed Mar. 28, 2008, the entire disclosure of which is incorporated herein by reference.

### BACKGROUND OF THE INVENTION

a) Field of the Invention

The invention relates to a toothed rack or threaded rod, in particular for a steering mechanism for a motor vehicle, which comprises a first rod-shaped part which, as a function element of the toothed rack or threaded rod, comprises at least one element for the conversion of a rotational movement into a translational movement, in particular a toothing and/or threading for the engagement of a threaded nut or of a threaded drive, and a second rod-shaped part which is connected with the first rod-shaped part and which preferably comprises at least one further function element of the toothed rack or of the threaded rod. At least one of the rod-shaped parts comprises a hollow volume opening out at a connection end of the rod-shaped part, and a connection pin is held in the hollow volume by press fit for the connection with the other rod-shaped part.

b) Description of Related Prior Art

Toothed racks or threaded rods, for example toothed racks or threaded rods employed in steering mechanisms of motor vehicles conventionally comprise several function regions each forming a section of the longitudinal dimension of the toothed rack or threaded rod. One function region serves for converting the rotational movement, such as is introduced by a steering wheel of a motor vehicle into a steering system, into a translational movement, such as is required in this example for turning the wheels of the motor vehicle. For this purpose one function region includes as a function element at least one toothing and/or threading for the engagement of a threaded nut, in particular a ball-type threaded nut, or of a threaded drive, in particular a ball-type threaded drive. At its ends in the axial direction the toothed rack or threaded rod comprises function elements for securing in position elements connected with the wheel, for example the tie rods. In a further function region, for example in addition to a toothing in the first function region, a threading, for example for a ball-type threaded gear, can further be provided in order to implement a threaded drive by means of a nut disposed on this threading. This threaded gear can be utilized for a power assistance of the steering movement. The toothed rack or threaded rod can, instead, also comprise in at least one further function region other types of function elements. For example, at one rod section of the toothed rack or threaded rod a piston for a power assistance of the steering can be provided or form elements for securing such in position. As such, a function region can also be a smooth rod section serving for the axial guidance of the toothed rack or threaded rod, and the rod section forms a bearing face. For the implementation of the several function elements, different fabrication steps must be completed in the production of the toothed rack or threaded rod.

To make possible better adaptation to the implementation of the individual function region, toothed racks are already known in which a first and a second rod-shaped part, each of which includes a function element of the toothed rack, are connection with one another. Apart from known welding of these two rod-shaped parts, WO 2006/066309 A1 furthermore discloses also a bolted connection of the two rod-shaped parts. A connection pin disposed on one part is herein provided with outer threads and is screwed into inner threads of an axial hollow volume, receiving the connection pin, of the other rod-shaped part. To secure this bolted connection in one embodiment, is an adhesive agent. In another embodiment example the wall encompassing the hollow volume receiving the pin is pressed at one site into an indentation of the pin. While through this implementation of the toothed rack with the division of the toothed rack into two or several rod-shaped parts having function regions, facilitation and improvement in the production is attained compared to the implementation of the toothed rack in one piece, the described bolted connection, however, also entails disadvantages, inter alia corresponding production expenditures and restrictions with respect to the implementation of the parts to be connected.

DE 198 22 313 A1 discloses a toothed rack for a steering mechanism for a motor vehicle with the above listed features. A first rod-shaped part, which has the toothing, is connected at its end, in which it is connected with the tie rods, with a piston rod, which forms a second rod-shaped part. The first rod-shaped part includes at its end a hollow volume and a connection pin of the second rod-shaped part has an outer diameter greater than the diameter of the hollow volume. When inserting the connection pin into the hollow volume a toothing of the connection pin cuts into the inner circumferential surface of the hollow volume, wherein also a certain press fit is formed. To secure against being pulled out, the circumferential wall of the first rod-shaped part behind the connection pin is swaged from the outside, whereby a form-fit closure is formed.

A similar device is also disclosed in JP 2001 030930 A.

DE 1 525 201 A shows further a nongeneric hardened bolt, which is composed of several sleeves with external bolt threads, which, after hardening and grinding through cores in the form of straight rods of nonhardened iron inserted through the sleeves were joined together to form a single bolt. The connection of the sleeves with the cores can take place by shrink-fitting or through a suitable bonding agent. As an embodiment example is cited a pintle bolt. This is viewed as a bolt which rotatingly connects two hinge parts of a hinge joint with one another, wherein only low tensile loadings are to be absorbed. The physical form described in DE 1 525 201 A permits the implementation of long, hardened bolts. The bolt disclosed in this document does not conform to the genus since it does not involve a threaded rod applicable for a steering mechanism suitable for the conversion of a rotational movement into a translational movement.

### SUMMARY OF THE INVENTION

The invention addresses the problem of providing a toothed rack or threaded rod of the above described type which is simple and advantageous in production. This is achieved according to the invention through a toothed rack or threaded rod comprising

a first rod-shaped part which comprises as a function element of the toothed rack or threaded rod at least one element for the conversion of a rotational movement into a translational movement and a hollow volume opening out at a connection end,

a second rod-shaped part which is connected with the first rod-shaped part and which comprises a hollow volume opening out at a connection end, and

a separate connection part via which the connection of the first with the second rod-shaped part takes place and which comprises first and second connection pins of which the first connection pin is held by press fit in the hollow volume opening out at the connection end of the first rod-shaped part and the second connection pin is held by press fit in the hollow volume opening out at the connection end of the second rod-shaped parts.

In a toothed rack or threaded rod according to the invention, which in particular represents a threaded gearing member, the connection of the first with the second rod-shaped part is completed via an additional connection part, which includes first and second connection pin, each of which is held by press fit in a hollow volume of the particular rod-shaped part. Consequently, the rod-shaped parts themselves do not need to be implemented with a connection pin but rather, they can have a hollow volume continuous over their length, thus they can be implemented in the form of tubes. Thereby the rod-shaped parts can be implemented in especially simple and advantageous form. Through the press fit of the connection part with the particular rod-shaped part a reliable connection between the first and the second rod-shaped part can be attained. After testing under operating conditions, it was found that herein the loadings occurring in a toothed rack or threaded rod, in particular for a steering mechanism for a motor vehicle, can be transmitted reliably and sustainably.

The connection part can in particular be implemented as a straight part with axially oriented coaxial connection pins, preferably lying precisely in one axis. In connection with also straight rod-shaped parts, an overall straight toothed rack or threaded rod can be implemented.

The connection pin or the connection pins of the connection part are advantageously considerably shorter than the first and second rod-shaped part; the length of the connection pin is preferably less than the four-fold, again preferably less than the two-fold, however always more than half, of the amount of the outer diameter of the connection pin.

Each of the connection pins held by press fit in a hollow volume is preferably provided in the region of the press fit with material elevations, in particular beads, webs, teeth or the like. The height of these material elevations is herein preferably in the range from 0.03 mm to 0.4 mm. Additionally, or instead, the wall of the particular hollow volume receiving a connection pin could also be provided with material elevations, in particular beads, webs, teeth or the like. The height of these material elevations is herein also preferably in the range from 0.03 mm to 0.4 mm.

These material elevations are with advantage introduced using a forming process, such as roller-burnishing or knurling, into the surface of the connection pin and, if feasible, also into the inner surface of the hollow volume. The advantage lies in the material hardening entailed therein which leads to the reduction of chips and the improvement of the connection.

In an advantageous embodiment of the invention, the outer contour of the engagement section has substantially the form of a cylinder shell, i.e. apart from the preferably provided outer material elevations, end-side chamfers or inlet slopes or the like. The inner hollow volume receiving the particular connection pin is preferably implemented substantially cylindrical, i.e. apart from optionally provided material elevations, an end-side inlet funnel or the like.

The press fit implemented between the particular connection pin and the particular pin-shaped part is at least force-fit in the axial direction. By utilizing residual resiliencies it is also conceivable and feasible to implement a component of the connection that acts under form-fit in the axial direction, for example by stress relief of a section of a material elevation disposed on the wall delimiting the hollow volume of the rod-shaped part and extending in the longitudinal direction, which section, referred to the slide-in direction of the connection pin, is located behind a material elevation disposed on the outer surface of the connection pin and extending in the circumferential direction.

In the circumferential direction each connection pin is held through the press fit at least under force-fit in the particular hollow. The connection is preferably additionally implemented such that it is form-fit. This can, for example, be attained through material elevations on the outer surface of the connection pin and/or on the wall encompassing the hollow volume in its region of the press fit, which during the implementation of the press fit form into or carve into the material of the other part connected via the press connection. The indentations implemented herein are preferably not, or only to a minimal degree,formed by machining, but rather entirely or at least largely through material displacement.

Before the forming production of the material elevations the inner diameter of the cylindrically implemented hollow volume is advantageously minimally greater than the outer diameter of the cylinder shell-shaped connection pin, such that both parts could be slid one into the other with minimal play, wherein only through the diameter enlargement or diameter reduction, respectively, entailed in the generation of the material elevations, in at least one of the two parts, the partial coverage necessary for the interference fit is obtained. It becomes thereby possible to compensate form, dimension and position discrepancies of the cylindrical inner form of the hollow volume and of the cylindrical shell surface of the connection pin. Further, the orientation of the parts to be jointed with respect to each other is simplified. The connection is additionally with advantage so laid out that a widening of the outer diameter of the region of the jointing partner into which the connection pin penetrates, is nearly prevented. The values of the widening of the outer diameter should herein be below 0.2 mm, especially preferably be below 0.05 mm. This reduces the material volume which must be removed if in the region of the jointing site a constant outer diameter is demanded. This further lowers the cracking risk in the wall of the hollow volume, such that the strength of the connection is ensured. In the case of a noncylindrical formation of the connection pin and of the hollow volume, this applies analogously. The only minimal widening in this case is even more important since nonround circumferential contours tend more readily to a notch effect and cracks can more easily form.

Within the scope of the invention, the term “toothed rack” comprises also a threaded rod which, for the conversion of the rotational movement into a translational movement, does not include toothing but rather only a threading for a threaded nut, for example a ball-type threaded nut, or a threaded drive, for example a ball-type threaded drive. Such threaded rods are applied in steer-by-wire steering systems, in which the rotational movement introduced by the steering wheel is, mechanically decoupled, transmitted via an auxiliary force device into a turning of the wheels. In the following description, consequently, under the term “toothed rack” the term “threaded rod” is also subsumed and under a toothing as a function element also the implementation as threading is subsumed.

### BRIEF DESCRIPTION OF THE DRAWING

Further advantages and details of the invention will be explained in the following with reference to the enclosed drawing drawings, in which:

FIG. 1 shows a first embodiment of a toothed rack according to the invention, in oblique view,

FIG. 2a shows a longitudinal center section in the connection region of the two rod-shaped parts,

FIG. 2b is a longitudinal section in the connection region of the two rod-shaped parts, in an alternative embodiment

FIG. 3 shows the toothed rack of FIG. 1 before the connection of the parts,

FIG. 4 shows a further embodiment of the invention, in oblique view,

FIG. 5 shows the toothed rack of FIG. 4 before the parts are pressed together,

FIG. 6 and FIG. 7 are longitudinal center section views in the connection region of toothed racks according to further embodiments of the invention,

FIG. 8 to 10 are longitudinal center section views through different embodiments of connection parts,

FIGS. 11 and 12 are oblique views of further toothed racks according to the invention,

FIG. 13 is an oblique view of one of the two rod-shaped parts (the toothed region is shortened) to be connected with one another, together with a connection part, according to a further embodiment of the invention,

FIG. 14 is a longitudinal center section of a section view of the toothed rack according to a further embodiment of the invention.

### DETAILED DESCRIPTION OF THE PREFERRED EMBODIMENTS

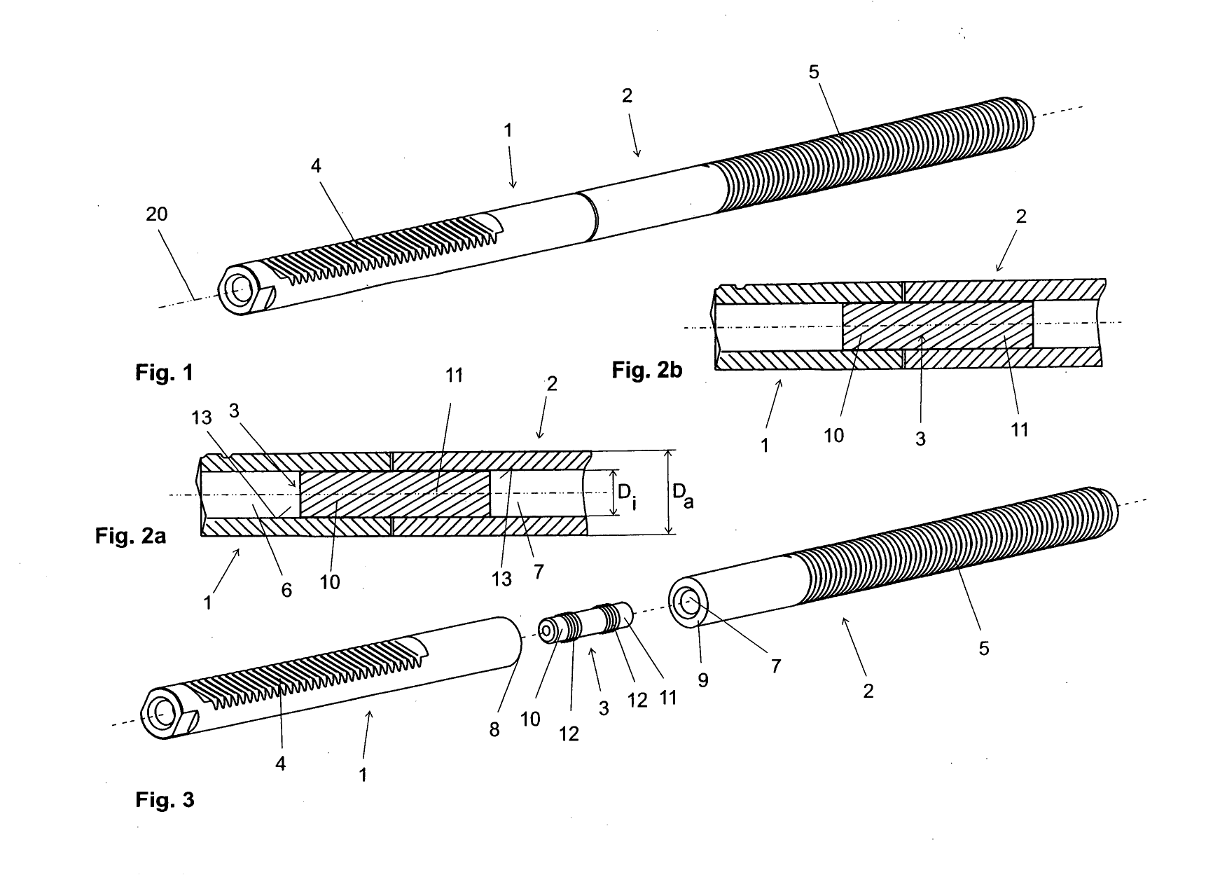

A first embodiment of a toothed rack according to the invention, for example for application in a steering mechanism of a motor vehicle, will be explained in the following with reference to FIG. 1 to 3. The toothed rack comprises a first and a second rod-shaped part 1, 2 connected with one another by means of a connection part 3. The first and the second rod-shaped part 1, 2 and the connection part 3 have a common longitudinal axis 20 (=the longitudinal axis of the toothed rack). The first rod-shaped part 1 has as a function element the toothing 4 of the toothed rack. The toothing 4 extends over a portion of the entire longitudinal dimension of the toothed rack and this portion of the longitudinal dimension of the toothed rack forms thus a first function region of the toothed rack.

The second rod-shaped part has as a function element a threading 5, for example for a ball-type threaded drive. This extends over a portion of the entire longitudinal dimension of the toothed rack and this portion of the longitudinal dimension of the toothed rack, consequently represents a second function region of the toothed rack, which is located in a different section of the longitudinal dimension of the toothed rack than the first function region.

Each of the first and the second rod-shaped parts 1, 2 consequently forms a different longitudinal section of the toothed rack.

The second rod-shaped part 2 could also include a different type of function element or a function region implemented in a different manner. When applied in a steering mechanism of a motor vehicle, the function region of the second rod-shaped part 2 could be, in particular, a part of an hydraulic steering power assistance.

The first and the second rod-shaped part 1, 2 each has a hollow volume 6, 7 extending in the axial direction. These volumes open out at the connection ends 8, 9 directed toward one another of the rod-shaped parts 1, 2. In the embodiment example according to FIG. 1 to 3 these hollow volumes 6, 7 extend continuously over the entire length of the rod-shaped parts 1, 2, i.e. the rod-shaped parts 1, 2 are implemented as tubes. However, the hollow volume 6 of the first and/or the hollow volume 7 of the second rod-shaped part 1, 2 could also only extend over a portion of the axial length of the rod-shaped part 1, 2.

In the state in which the rod-shaped parts 1, 2 are connected with one another, in each of the sections of the hollow volumes 6, 7 adjoining the connection ends 8, 9 is held one section of the connection part 3. Each of the sections of the connection part 3 resting in the particular hollow volume 6, 7 represents a connection pin 10, 11 via which the connection part 3 is connected through a press fit with the particular rod-shaped part 1, 2. In the embodiment example according to FIG. 1 to 3 the connection part 3 is overall formed by these connection pins 10, 11, i e. the two connection pins 10, 11 extend from the site at which, in the assembled state of the toothed rack, are located the connection ends 8, 9 of the two rod-shaped parts 1, 2, axially in opposite directions.

However, between the two connection pins 10, 11 could also be located one or several further sections of the connection part 3, which, in the following, will still be described by example.

The connection pins 10, 11 of connection part 3 are provided with material elevations 12 during its production, cf FIG. 3. These material elevations 12 are deformed when the particular pin 10, 11 is pressed into the particular hollow volume 6, 7, whereby a strong and secure press fit can be implemented.

The material elevations 12 can be formed, for example, by combs, webs, teeth, beads or the like. In the embodiment example according to FIG. 1 to 3 these material elevations extend in the circumferential direction. In this connection the combs, webs or teeth can exhibit an annular course or a pitch in the manner of threadings can be provided. Such material elevations 12 can also be referred to as roller-bumishings or as annular groove knurlings.

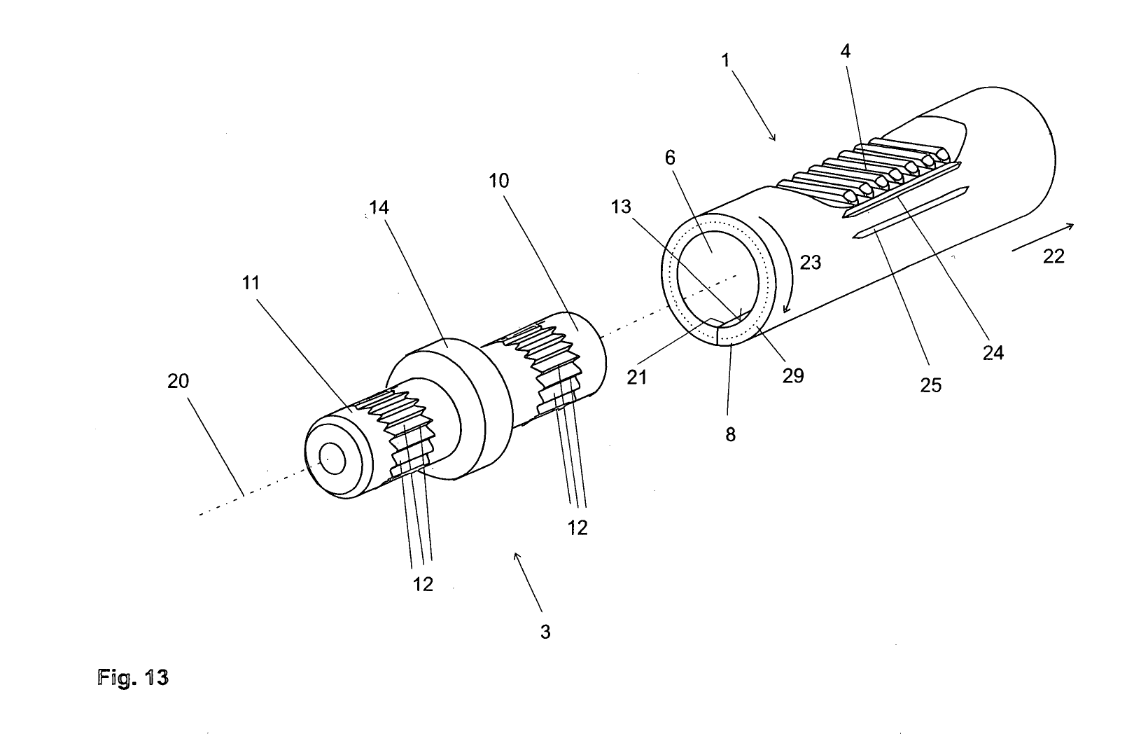

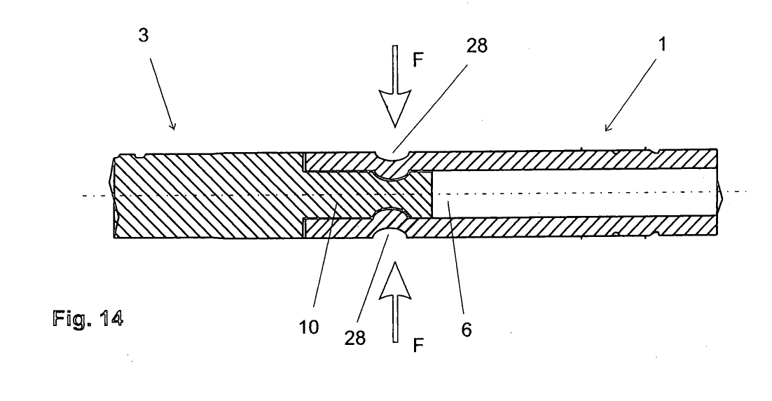

The material elevations 12 formed by beads, webs, teeth or the like, can also have a different form, they could, for example, extend in the axial direction, as is indicated in FIG. 13. Such axially extending material elevations are also referred to as axial groove knurlings. Webs, beads or teeth or other types of material elevations, for example diamond knurlings extending in an oblique direction could also be provided.

The material elevations 12 can preferably be implemented through material displacement, in particular by means of rolling tools, such as serve also for the production of rolled-on threadings.

In addition to, or instead of, the material elevations 12 of connection pins 10, 11, the wall 13 delimiting the particular hollow volume 6, 7 can be provided with material elevations at least in the section in which the press connection with the connection pin 10, 11 is completed. These material elevations can have the form already described in connection with the connection pins 10, 11. A preferred embodiment of such material elevations on the wall 13 of the particular hollow volume 6, 7 are herein teeth extending in the axial direction. Such teeth can form out indentations in the latter or in its material elevations 12 when the associated connection pin 10, 11 is pressed in. Through these indentations a connection can be implemented acting under form closure against a relative turning out of place of the connection pin 10, 11 with respect to the wall 13. Such indentations are preferably formed when the connection pin 10, 11 is pressed in, such that they are not or only to a small degree chip-forming but rather are formed entirely, or at least largely, through material displacement.

In the preferred case, in which the material elevations are implemented by forming, the outer diameter d of the cylindrical connection pin is minimally smaller than the inner diameter Di of the cylindrical hollow volume, such that without the encircling material elevations, the connection pin can be slid into the hollow volume with minimal play. Only through the material elevations on the connection pin, whose outer circumference describes a diameter d+2x, is the interference required for the press fit attained. Alternatively, or also in combination, this applies to the material elevations along the inner diameter of the hollow volume. The interference is herein preferably dimensioned at a size in the range from 0.05 mm to 0.25 mm, especially preferably approximately from 0.1 to 0.15 mm.

The press fit is advantageously laid out such that the outer diameter Da of the rod-shaped part does not expand by more than 0.2 mm, preferably by less than 0.1 mm.

The same applies also to non-cylindrical cross sections of the connection pin. In this case, the twofold distance of the outer section in the particular angular section from the longitudinal axis is assumed as the diameter, such as is conventional when using polar coordinates.

Through the press fit of the connection pins 10, 11 in the hollow volumes 6, 7 a connection acting under force-fit is implemented. The springback effects in addition a component of the connection acting under form fit in the axial direction, acting, for example through stress relief of a section of a material elevation disposed on the wall 13 and extending in the longitudinal direction, which section, referred to the slide-in direction, is located behind a material elevation 12, extending in the circumferential direction, of the connection pin 10, 11.

The connection of each of the rod-shaped parts 1, 2 with the connection part 3 is established in simple manner by axially pressing them together. One connection pin 10, 11 of the connection part 3 can first be pressed into one of the rod-shaped parts 1, 2 and subsequently the other connection pin 10, 11 into the other rod-shaped part 1, 2. So that during the second pressing process the connection pin 10, 11 already pressed in during the first pressing process, is not pressed deeper into the hollow volume 6, 7, various measures can be provided. The hollow volume 6, 7 can, for example, have a tapered diameter in order to limit the press-in-depth of the connection part 3. Another feasibility comprises forming the connection pins 10, 11 to be differently long and having different lengths of the press connection in the pressed-in state, as is illustrated in FIG. 2b. The connection pin with the greater press-in length is pressed in first. When hereupon the other connection pin is pressed in, the force occurring herein can be absorbed by the already pressed-in connection pin without increasing the press-in depth of the same.

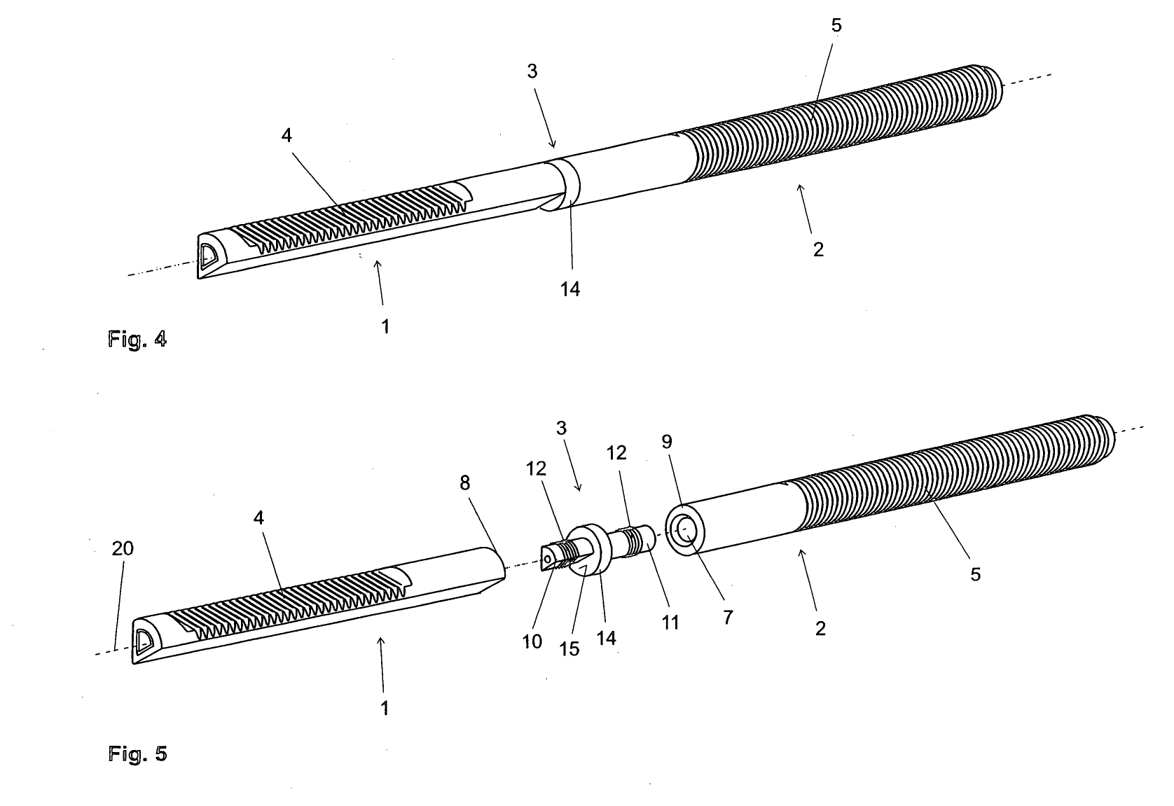

A further feasibility is depicted in the embodiment example according to FIGS. 4 and 5. The connection part 3 has herein a collar 14, wherein the connection pins 10, 11 project in opposite directions coaxially from the section, comprising the collar 14, of the connection part 3. In the pressed-together state the contact faces 15, oriented in the axial direction, of the collar 14 are in contact with their end sides on the first and second rod-shaped part 1, 2. In the assembled state the outer surface of collar 14 forms a section of the outer surface of the toothed rack, which is flush with the outer surfaces, adjoining the connection ends 8, 9 of rod-shaped parts 1, 2. The outer surface of the collar 14 can also have a smaller diameter than that of the rod-shaped parts 1, 2 in their sections adjoining the connection ends 8, 9 and the collar 14 can be received in end-side indentations of the rod-shaped parts 1, 2 in the connected state of parts 1, 2, 3.

The invention also makes feasible the production of toothed racks with non-cylindrical cross sectional faces. This is illustrated in FIGS. 4 and 5. It is herein possible to connect rod-shaped parts 1, 2 with different cross sections as well as also rod-shaped parts 1, 2 with substantially equal cross sections. It becomes thereby feasible to lay out and produce each longitudinal section of the toothed rack in simple manner with the cross section optimal for the particular application and subsequently to join together the separate parts to form a complete toothed rack. Depending on the dimensioning, a substantially cylindrical connection pin 10 can serve for the connection in cooperation with a substantially cylindrical or also in cooperation with a hollow volume 6 adapted to the outer form, as well as also a connection pin 10 adapted to the outer form.

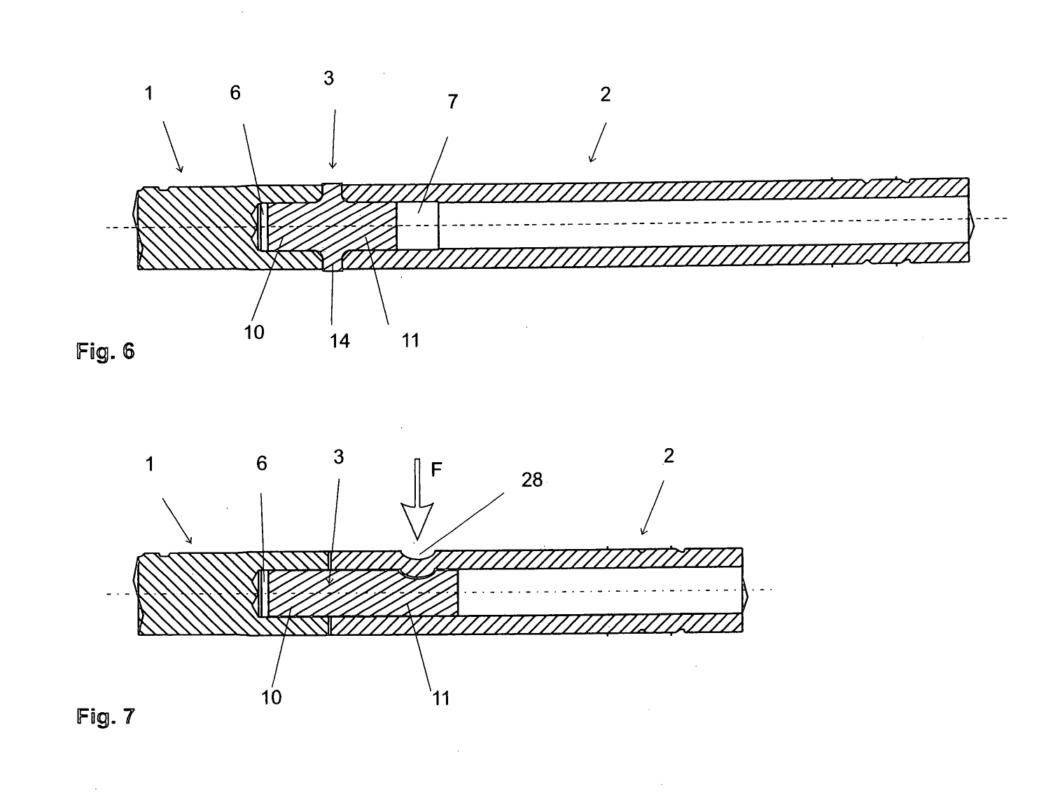

The hollow volume 6, 7 of the first and/or of the second rod-shaped part 1, 2 can also be implemented such that it is not continuous over the length of the rod-shaped part 1, 2. Such an embodiment example is depicted in FIG. 6. The hollow volume 6 of the first rod-shaped part 1 is here implemented in the form of a pocket hole extending from the connection end 8 at its end side. Instead of, or additionally, such an implementation can also be provided for the second rod-shaped part 2.

FIG. 7 shows an embodiment in which, for the additional securement of the press connection of connection pin 11 with the second rod-shaped part 2, the second rod-shaped part 2 after the connection pin 11 has been pressed into, is radially pressed in the connection region with the connection pin 11. A force F exerted by an appropriate tool is indicated by an arrow. Through this press-in 28 the corresponding section of the shell encompassing the hollow volume 7 is pressed into or swaged with an indentation of the connection pin 11. Instead of, or additionally, the connection pin 10 could also be additionally secured in this manner in the hollow volume 6 of the first rod-shaped part 1.

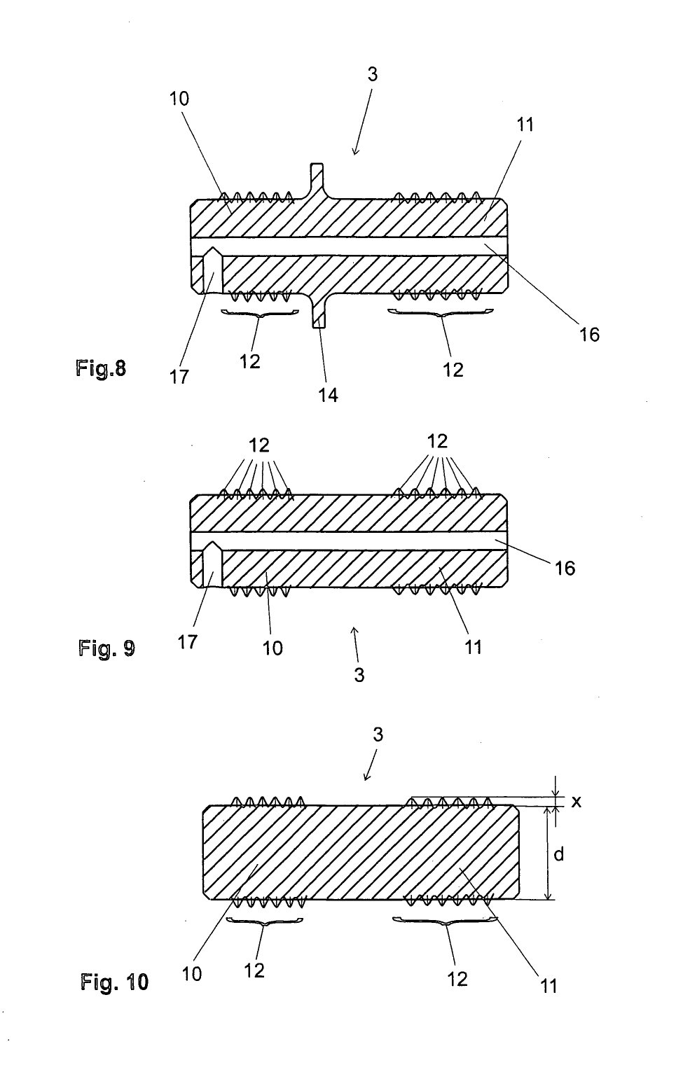

In FIG. 8 to 10 are shown examples for feasible embodiments of the connection part 3. In the embodiment according to FIG. 8 between the two connection pins 10, 11, similar to the embodiment depicted in FIG. 4 to 5 and as in the embodiment depicted in FIG. 6, an outwardly projecting collar 14 is provided. The connection part 3 includes an inner channel 16 continuous over its length and opening out at the front-side ends of its two connection pins 10, 11. Further, as depicted, for example at least one radial bore 17 can be provided, which extends from the inner channel 16 up to the shell surface of a connection pin 10, 11.

The embodiment shown in FIG. 9 corresponds to the embodiment of FIG. 8, however, without a collar 14 being provided.

FIG. 10 shows a further embodiment which corresponds to that of FIG. 9, however, without an inner channel being provided.

Several further embodiments of connection parts 3 with connection pins 10, 11 extending axially in opposite directions are conceivable and feasible.

In the embodiment shown in FIG. 1 the first rod-shaped part 1, as already previously described, includes a toothing 4 as a function element. The second rod-shaped part 2 is here provided with a piston 18 as a function element. This piston 18 can be disposed in a cylinder (not shown), in particular in order to fulfill a booster assistance function in a steering mechanism. The first and the second rod-shaped part 1, 2 are connected in the previously described manner through a separately fabricated connection part 3 which here includes a collar 14. However, it can also be implemented in another previously described manner.

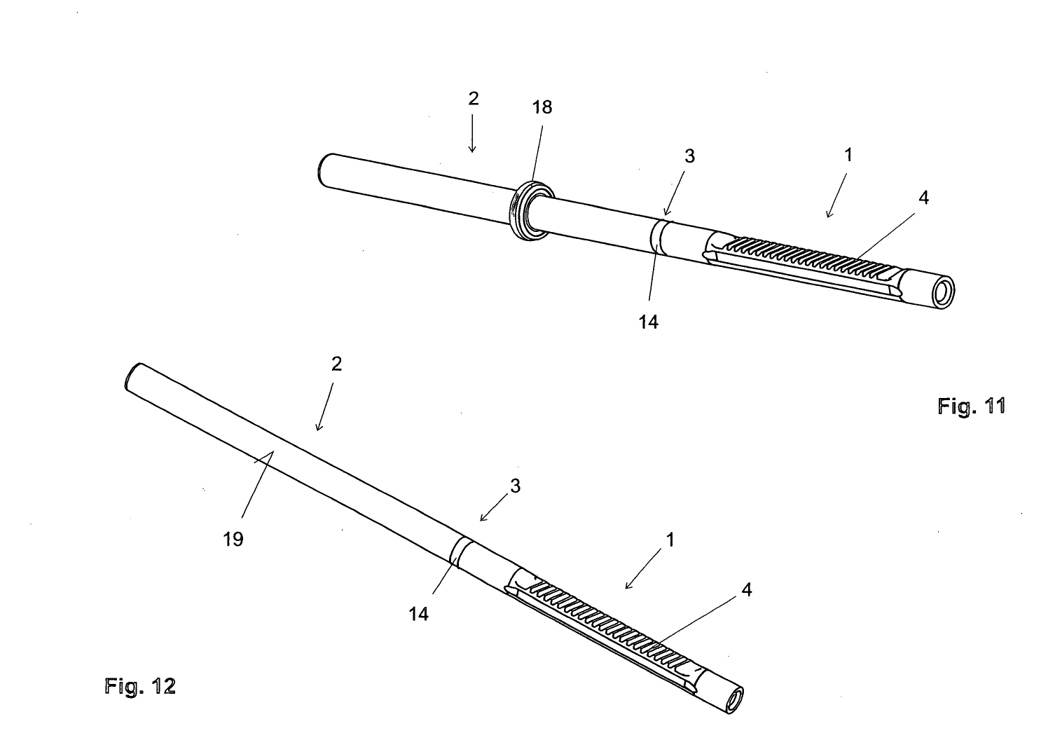

The embodiment example shown in FIG. 12 differs from the embodiment depicted in FIG. 11 thereby that the second rod-shaped part 2 includes as a function element an external guide surface 19, which in connection with a (not shown) guide part, serves for forming an axial guidance of the toothed rack.

In all depicted embodiments at the end of the second rod-shaped part 2 remote from the first rod-shaped part 1, as the function element a connection element can be disposed for the connection with a part actuated by the toothed rack. This function element can also be the sole function element of the second rod-shaped part 2.

The second rod-shaped part 2 can also at the end remote from the first rod-shaped part 1 be connected with a further rod-shaped part, in particular through a connection corresponding to the connection between the first and the second rod-shaped part 1, 2. The sole function of the second rod-shaped part 2 can herein also be the connection function with this further rod-shaped part, which can comprise a further function element.

At the end remote from the second rod-shaped part of the first rod-shaped part 1, it can be connected with one or several further rod-shaped parts, in particular through a connection corresponding to the connection between the first and the second rod-shaped part 1, 2. At least one of these further rod-shaped parts can comprise a further function element.

In this manner, from more than two single parts produced separately, using the method according to the invention, a toothed rack can be formed.

The embodiment shown in FIG. 13 is initially intended to illustrate a further feasible implementation for the material elevations 12 on the connection pins 10, 11. These are here formed by teeth extending in the axial direction, wherein these teeth encompass annularly the particular connection pin 10, 11 overall. Instead of teeth, webs or beads could also be provided, for example. Such material elevations extending in the axial direction could also be utilized in the connection pins of the previously described embodiment examples. On the other hand, the material elevations 12 of the embodiment depicted in FIG. 13 could also be implemented in a different manner.

The first rod-shaped part 1 shown in FIG. 13 is implemented by forming from a planar sheet metal. The sheet metal is curved tubularly and encompasses the longitudinal axis 20. The edges, coming to lie in contact with one another, of the sheet metal can be connected with one another by a welding seam 21. Onto the outside of the first rod-shaped part 1 is stamped the toothing 4. This stamping can be carried out when the sheet metal is still in its planar state or when it is already partially curved. In order to affect as minimally as possible the form of the already stamped toothing during the further forming of the sheet metal following the stamping of the toothing, at least one attenuation 24, 25 is introduced viewed in the circumferential direction 23, in front of and behind the toothing 4. The attenuation, referred to in the longitudinal direction 22 of the toothed rack 1, extends at least over a portion of the length of the toothing 4 next thereto. In the depicted embodiment on both sides of the toothing 4 two linear attenuations 24, 25 are disposed at different spacings from the toothing 4 extending over the entire longitudinal extent of the toothing 4 next thereto.

Through the at least one linear attenuation 24, 25 extending on the side of toothing 4, the tension distribution, introduced into the sheet metal through subsequent forming steps, can be affected. Thus, for example bending stresses are only transmitted to a minimal extent via attenuations, for example beads or also milled recesses, extending transversely to the bending line 29. At least the major portion of the stress is relieved through a deformation at the site of the attenuation. If through the implementation of the attenuations offsets or edges are introduced into the workpiece, the material flow can be strongly reduced during a subsequent forming through the siting of these offsets or edges on the tool. The attenuations form in this case simultaneously also holding edges for the forming tool. Conceivable and feasible would, for example, also be forming holding edges which do not simultaneously also represent an attenuation. In this case the substance flow is also hindered by the contact with the tool.

Through such attenuations 24, 25 and/or holding edges, which delimit a partial region of the sheet metal with reference to the direction of the bending line 29 of the sheet metal piece in a subsequent bending operation, form changes through this subsequent bending operation can consequently be substantially decreased, whereby fewer or no posttreatment steps of the introduced toothing 4 are required after completion of the bending process of the first rod-shaped part 1.

Alternatively to the implementation of the rod-shaped part 1 with a substantially cylindrical outer surface, the above described method can also be applied for the implementation of other cross sectional forms, such as are shown by example in FIG. 4.

In the embodiment shown in FIG. 14 the connection pin 10 is disposed directly on a connection part 3, which here has a longer axial extent compared to the previously described connection parts and which is depicted in FIG. 14 only over a section of its axial extent. At the not depicted end, analogously, a connection with the second rod-shaped part, not shown in FIG. 14, could be carried out.

Instead, the connection pin 10 could also be disposed directly on the second rod-shaped part. The part shown in FIG. 14 on the left would in this case be this second rod-shaped part. The connection of the second rod-shaped part 2 with the first rod-shaped part 1 could herein also take place through all other previously described embodiments of connection pins or the hollow volumes receiving these pins.

In the embodiment according to FIG. 14 two opposite press-ins for the securement of the connection are shown schematically.

Each of the hollow volumes 6, 7 receiving a connection pin 10, 11 preferably includes a funnel-shaped widening adjoining the connection end 8, 9 in order to facilitate pressing in a connection pin. In addition, or instead, a particular connection pin 10, 11 can be tapered toward its end.

As is evident based on the above specification, the scope of the invention is not limited to the depicted embodiments, but rather should be determined with reference to the attached claims together with their full range of possible equivalents.

### LEGEND TO THE REFERENCE SYMBOLS

1 First rod-shaped part
2 Second rod-shaped part
3 Connection part
4 Toothing
5 Threading
6 Hollow volume
7 Hollow volume
8 Connection end
9 Connection end
10 Connection pin
11 Connection pin
12 Material elevation
13 Wall
14 Collar
15 Contact face
16 Channel
17 Radial bore
18 Piston
19 Guidance surface
20 Longitudinal axis
21 Welding seam
22 Longitudinal direction
23 Circumferential direction
24 Attenuation
25 Attenuation
28 Press-in
29 Bending line
d Outer diameter
Di Inner diameter
Da Outer diameter
x Distance {Translator: should be omitted}

1. A toothed rack or threaded rod for a steering mechanism for a motor vehicle, comprising:
a first rod-shaped part which, as a function element of the toothed rack or threaded rod, comprises at least one element for the conversion of a rotational movement into a translational movement, the at least one element comprising a toothing and/or a threading for the engagement of a threaded nut or a threaded drive; and
a second rod-shaped part which is connected with the first rod-shaped part and which comprises preferably at least one further function element of the toothed rack or threaded rode,
wherein at least one of the rod-shaped parts includes a hollow volume opening out at a connection end of the rod-shaped part, a connection pin is held by press fit in the hollow volume,
wherein the connection of the first with the second rod-shaped part is established via a separate connection part, which comprises first and second connection pins, and
wherein the first connection pin is held by press fit in the hollow volume, opening out at the connection end, of the first rod-shaped part and the second connection pin (11) is held by press fit in the hollow volume, opening out at the connection end, of the second rod-shaped part.

2. The toothed rack or threaded rod as claimed in claim 1, wherein at least one connection pin, preferably each of the connection pins includes material elevations.

3. The toothed rack or threaded rod as claimed in claim 2, wherein the material elevations are implemented using forming processes as webs, beads or teeth extending in the circumferential direction.

4. The toothed rack or threaded rod as claimed in claim 2, wherein the material elevations form the requisite interference required for a press fit of the outer diameter of the connection pin with respect to the inner diameter of the hollow volume in which the connection pin is held.

5. The toothed rack or threaded rod as claimed in claim 1, wherein the length over which the first connection pin is connected with the first rod-shaped part via the press fit, is greater than the length over which the second connection pin is connected via the press fit with the second rod-shaped part.

6. The toothed rack or threaded rod as claimed in claim 1, wherein the connection part comprises between the first and the second connection pin a collar which includes contact faces for the contact on end sides faces of the first and second rod-shaped part.

7. The toothed rack or threaded rod as claimed in claim 1, wherein at least one hollow volume, preferably each hollow volume receiving a connection pin has a funnel-shaped widening toward the connection end.

8. The toothed rack or threaded rod as claimed in claim 1, wherein the first and/or the second rod-shaped part for the securement of the connection with the connection pin is provided with a press-in which engages into an indentation in the connection pin.

9. The toothed rack or threaded rod as claimed in claim 1 wherein the hollow volume of the first and/or of the second rod-shaped part extends at least over the major portion of the length, preferably over the entire length, of the rod-shaped part.

10. The toothed rack or threaded rod as claimed in claim 1, wherein the connection part includes an inner channel.

11. The toothed rack or threaded rod as claimed in claim 1, wherein the connection part is implemented such that it is straight and the connection pins extend axially in opposite directions.

12. The toothed rack or threaded rod as claimed in claim 1, wherein at least one hollow volume, preferably each of the hollow volumes, receiving a connection pin comprises material elevations on its wall in a section of its longitudinal dimension in which the press fit is formed.

13. The toothed rack or threaded rod as claimed in claim 12, wherein the material elevations are implemented as webs, beads or teeth extending in the axial direction.

14. A steering mechanism for a motor vehicle with a toothed rack or threaded rod as claimed in claim 1.
